(19) United States
(12) Patent Application Publication
(10) Pub. No.: US 2002/0090602 A1
(43) Pub. Date: Jul. 11, 2002

(54) Family life educational training and supportive services program as applied to transitional, community-based, correctional centers

(76) Inventor: Gary L. Hall, Philadelphia, PA (US)

Correspondence Address: James N. Gross, Esquire, Suite 1400, 117 South 17th Street, Philadelphia, PA, 19103-5011, US

(21) Appl. No.: 09/981,814

(22) Filed: Oct. 19, 2001

Related U.S. Application Data
(60) Provisional application No. 60/240,391, filed on Oct. 20, 2000.

(51) Int. Cl. G09B 9/00

(52) U.S. Cl. 434/433

(57) ABSTRACT

The novelty or new “art” or approach which this model represents is that of providing a multi-faceted, social services program for inmates while being housed at transitional correctional centers. There is no existing model which offers family/parent, educational and job skills training and supportive services for inmates during their period of incarceration at transitional correctional centers just prior to “re-entry”.

### CROSS-REFERENCE TO RELATED APPLICATIONS

Not Applicable.

### BACKGROUND

1. Field of Invention

This invention or model relates to the application of a broad-based social services program to be instituted at transitional, correctional (penal) centers to reduce and/or eliminate recidivism.

### BRIEF SUMMARY OF THE INVENTION

Nationally, the overcrowding in prison systems has precipitated the use of halfway houses and/or transitional residences for inmates. Unfortunately, the few social tools made available to inmates in these transitional residences have proven to be scarce and ineffective, as evidenced by the escalating rate of recidivism. There has not been one comprehensive social service model which has been applied uniformly to transitional residences for the benefit(s) of inmates prior to re-entry into society. This invention or model incorporates family/parent, educational and job skills training, and supportive services designed to successfully prepare residents of transitional correctional centers to re-enter society. The program of the Applicant is composed of a multi-faceted training program designed to empower individuals with the everyday skills covering the spectrum from parenting to job-readiness. The program model is designed to realize the following objectives:

1. To involve and engage residents of transitional correctional centers in self-improvement through workshops, seminars and counseling sessions designed for those to learn the practical aspects of living;

2. To provide residents/inmates with basic knowledge and skills necessary for self-reliance and self-sufficiency;

3. To educate inmates as to the importance of family, its role in nurturing individual growth, and how a strong family can protect people in times of adversity;

4. To learn the value of empowerment.

### BRIEF DESCRIPTION OF THE SEVERAL VIEWS OF THE DRAWING

Not Applicable.

### Statement Regarding Federally Sponsored Research or Development

Not Applicable.

### Reference to a Microfiche Appendix

Not Applicable.

### DETAILED DESCRIPTION OF THE INVENTION

The invention or model represents a multi-faceted social services program designed to successfully prepare residents of transitional, community-based, correctional centers to re-enter society. The program is designed to offer training, to enhance inmates' skills from parenting to job-readiness. This program or model need not be distinguished from other programs or models, due to the fact of the non-existence of same.

### Abstract of the Disclosure

Not Applicable.

### Drawings

Not Applicable.

### Oath or Declaration

See form PTO/SB/01.

1. What is being claimed as the invention is the compilation of a broad-based, multi-faceted, social services program offered to inmates at transitional, community-based, correctional centers for re-entry skills covering the areas of parenting to job-readiness:
